(19) United States
(12) Patent Application Publication
(10) Pub. No.: US 2011/0191123 A1
(43) Pub. Date: Aug. 4, 2011

(54) Virtual Lifestyle, Health, and Wellness Management System and Method

(76) Inventor: Christopher G. Buzynski, Depew, NY (US)

(21) Appl. No.: 13/020,653

(22) Filed: Feb. 3, 2011

Related U.S. Application Data
(60) Provisional application No. 61/301,065, filed on Feb. 3, 2010.

(51) Int. Cl. G06Q 50/00

(52) U.S. Cl. 705/3

(57) ABSTRACT

A system for managing the wellness of an individual has a kiosk where data is received from and provided to the individual. The kiosk comprises a processor, a display in communication with the processor, a data entry device in communication with the processor, and a bio-electric impedance analysis (“BEIA”) bar capable of communication with the processor. The kiosk has a communication device in communication with the processor. The system further comprises a server computer in network communication with the communication device of the kiosk. The server computer has a storage device for storing data. The server computer may be used to store data received from an individual, or provide data to the individual, using a kiosk. The system may further comprise fitness equipment, medical equipment, client computers, or any combination of such devices. These devices may be in communication with the kiosk and/or server computer.

### CROSS-REFERENCE TO RELATED APPLICATION

This application claims the benefit of priority to U.S. provisional patent application Ser. No. 61/301,065 filed Feb. 3, 2010, now pending, the disclosure of which is incorporated herein by reference.

### FIELD OF THE INVENTION

The invention relates to the field of physical fitness and well being.

### BACKGROUND OF THE INVENTION

The health and wellness of an individual is of obvious importance to that individual. But, it may also be important to other parties. For example, a military trainee's health and wellness is important to his or her superior officers and of the organization as a whole, the health and wellness of an athlete is important to the team and owners, and the health and wellness of any individual is important to that person's doctors, insurers, and other caregivers.

There is a need for a system that aids in tracking and managing the health and wellness of an individual for purposes determined by that individual. The purposes may then involve sharing the tracked information with professionals (e.g., doctors, trainers, therapists, insurers, etc.).

### BRIEF SUMMARY OF THE INVENTION

A system for managing the wellness of an individual is provided. The system has a kiosk where data is received from and provided to the individual. The kiosk comprises a processor, a display in communication with the processor, a data entry device in communication with the processor, and a bio-electric impedance analysis (“BEIA”) bar capable of communication with the processor. The kiosk has a communication device in communication with the processor.

The system further comprises a server computer in network communication with the communication device of the kiosk. The server computer has a storage device for storing data. The server computer may be used to store data received from an individual, or provide data to the individual, using a kiosk.

The system may have a biometric reader. The system may further comprise fitness equipment, medical equipment, client computers, or any combination of such devices. These devices may be in communication with the kiosk and/or server computer.

The present invention may be embodied as a kiosk similar to that described above. The kiosk has a processor, a display in communication with the processor, a data entry device in communication with the processor, a BEIA bar in communication with the processor, and a storage device in communication with the processor.

The present invention may be embodied as a method of managing the wellness of an individual. The method comprises the steps of providing a kiosk for interaction with the individual, providing a server computer in network communication with the communication device of the kiosk, determining biofeedback information of the individual using the bio-electric impedance analysis bar of the kiosk, and recording the biofeedback information to the storage device of the server computer. Wellness information of the individual is entered using the data entry device of the kiosk, and the wellness information is recorded to the storage device of the server computer.

### DESCRIPTION OF THE DRAWINGS

For a fuller understanding of the nature and objects of the invention, reference should be made to the following detailed description taken in conjunction with the accompanying drawings, in which:

FIG. 1 is a schematic diagram of a system according to an embodiment of the present invention;

FIG. 2 is a schematic diagram of a kiosk according to another embodiment of the present invention; and

FIG. 3 is a flowchart diagram of a method according to another embodiment of the present invention.

### DETAILED DESCRIPTION OF THE INVENTION

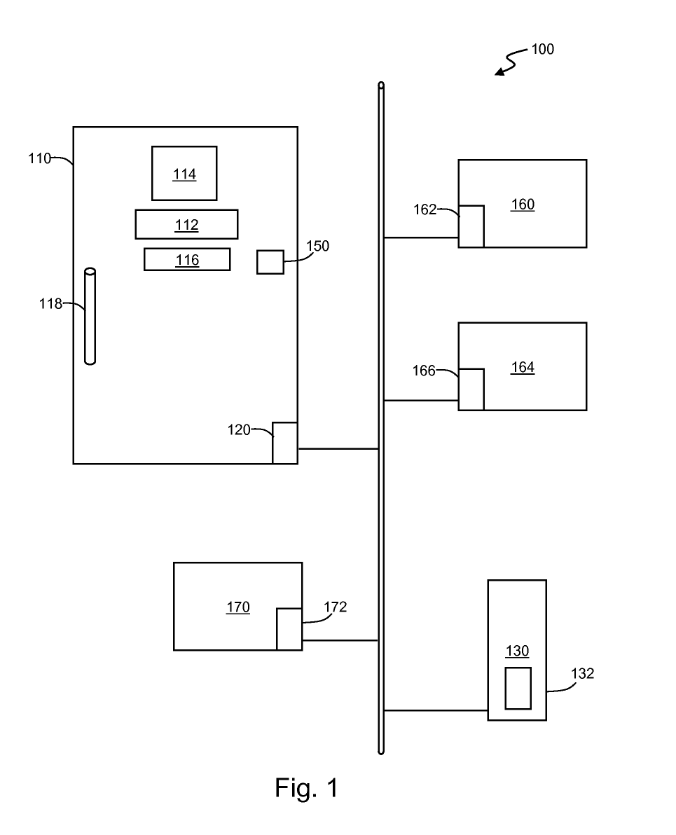

In an embodiment of the present invention, a system 100 for managing the wellness of an individual is provided. See, e.g., FIG. 1. Wellness is used herein to describe the various aspects of an individual's well-being, for example, without limitation, physical health, medical status, nutritional health, etc. The system 100 has a kiosk 110 where data is received from and provided to the individual. The individual may provide information such as physical statistics (e.g., height, weight, gender, age, etc.), medical statistics (e.g., heart rate, blood pressure, body temperature, etc.), mental state (e.g., mood, etc.), nutritional facts (e.g., caloric intake for the day, breakdown of nutritional details for food eaten, etc.), and other parameters deemed useful for the purposes of tracking and/or managing a individual's wellness.

The kiosk 110 comprises a processor 112 and a display 114 in communication with the processor 112. The processor 112 may be a computer such as a desktop computer, or other computer, as is known in the art. In an embodiment, the processor 112 and display 114 may be combined in one device such as, for example, an “all-in-one” computer. The kiosk 110 further comprises a data entry device 116 in communication with the processor 112. An individual may use the data entry device 116 to enter data and other information for processing by the processor 112. The data entry device 116 may be a keyboard, a mouse, a touchpad, or other input device commonly known in the art. In an embodiment, the display 114 and the data entry device 116 may be combined as, for example, a touch-screen monitor. In an embodiment, the processor 112, the display 114, and the data entry device 116 may be combined in a device such as, for example, an all-in-one computer with a touch-screen.

The kiosk 110 further comprises a bio-electric impedance analysis (“BEIA”) bar 118 capable of communication with the processor 112. The BEIA bar 118 is capable of measuring various physiologic parameters. For example, without limitation, the BEIA bar 118 may measure the heart rate, or body fat percentage, or temperature of a person grasping the bar.

The kiosk 110 further comprises a communication device 120 in communication with the processor 112. The communication device 120 is capable of network communication such that the processor 112 of the kiosk 110 may communicate with other network devices. For example, without limitation, the communication device 120 may be an Ethernet adapter, a wireless Ethernet adapter, a Bluetooth® adapter, or a cellular adapter.

The kiosk 110 may further include a biometric reader 150 for identifying an individual, authenticating an individual, or both. The biometric reader 150 may be of any kind known in the art. The biometric reader 150 may be, for example, without limitation, a finger/thumb print reader or a retinal scanner. Identification and authentication may be done by more traditional means by, for example, user name and password combination or swipe-card reader.

The system 100 further comprises a server computer 130. The server computer 130 may be collocated in the same facility as the kiosk 110 or the server computer may be located in a remote facility. The server computer 130 is in network communication with the communication device 120 of the kiosk 110. In an embodiment, both the kiosk 110 and the server computer 130 are network-attached to the Internet. The server computer 130 has a storage device 132, such as, for example, a hard disk drive, for storing data. In this way, the server computer may be used to store data received from an individual using a kiosk 110. The server computer 130 may also provide previously-stored data to the individual.

In another embodiment of the system 100, more than one kiosk 110 may be used. The kiosks 110 may be located in key, wellness-related locations. For example, a kiosk 110 may be located in a gym, a doctor's office, an individual's place of employment, or a supermarket.

In an embodiment, the processor 112 is a thin client. As such, the processor 112 may rely on the server computer 130 for programmatic instruction. In this way, the processors 112 of one or more kiosks 110 may use programs stored on the server computer 130 to operate. The programs may be administered centrally, reducing the need for maintenance staff visiting kiosks in order to effect changes to the programs of the processors. Use of thin client methods is known in the art to aid in lowering the costs of maintaining remote systems.

A system 100 according to an embodiment of the present invention may further comprise fitness equipment 160 having a network adapter 162. The fitness equipment 160 may be located in a gym where a kiosk 110 is located. The fitness equipment 160 may be in network communication with the kiosk 110. In this way, the fitness equipment 160 may communicate with the kiosk 110 to send information regarding an individual's use of the fitness equipment 160. For example, the fitness equipment may send workout data such as, without limitation, duration of use, calories burned, distance travelled, difficulty level, weight used, etc. The fitness equipment 160 may be any equipment commonly known. For example, the fitness equipment 160 may be a treadmill, an elliptical, a stair climber, a rowing machine, a bicycle, strength training equipment (e.g., Nautilus® machines), etc. more than one piece of fitness equipment 160 may be network-connected.

The fitness equipment 160 may be in network communication with the server computer 130. In this way, the fitness equipment may communicate and interact directly with the programs and storage device 132 of the server computer 130 to send the workout data of an individual to the server computer 130. As such, the fitness equipment may be located in the home of an individual.

A system 100 according to an embodiment of the present invention may further comprise medical equipment 164 having a network adapter 166 in network communication with a kiosk 110. As such, the medical equipment 164 may communicate information regarding an individual's medical status to the system 100 (kiosk 110 and/or server computer 130). For example, the medical equipment may be an electrocardiogram communicating an individual's heart rhythm, a blood pressure apparatus for communication an individual's blood pressure, a pulse oximeter communicating an individual's blood-oxygen level, etc.

The network adapter 162 of the fitness equipment 160, or the network adapter 166 of the medical equipment 164, or any network communications described herein may be of any type commonly used in the art. Components of a system 100 may communicate over wired or wireless Ethernet networks, Bluetooth® wireless networks, cellular phone (e.g., 2.5 G, 3 G, 4 G) networks, or any other type of networking protocol.

A system 100 according to an embodiment of the present invention may further comprise one or more client computers 170 having a network adapter 172 for network communication with the server computer 130 or a kiosk 110. The client computer 170 may be used to access information and programs stored on the server computer 130. In an embodiment, the client computer 170 may have a web browser and the server computer 130 may comprise a web server. The client computer 170 may be a personal computer, portable communication devices (e.g., smartphones, tablets, netbooks, etc.), or any other type of client computer that can access the programs and information stored on the storage device 132 of the server computer 130.

In use, a system 100 according the present invention provides the ability for an individual to manage and track his or her wellness. The system 100 is a network-based virtual environment that is hosted on a main secure server computer 130. Initial setup of the system 100 may be completed on location by professionals (doctors, trainers, coaches, educators, insurance companies, medical professionals, and evaluators) so that individuals (clients, patients, trainees, athletes, and students) can begin to create individual profiles. A kiosk 110 will be the primary data-gathering instrument throughout the service to an individual. Professionals will be able to access the gathered data of an individual via, for example, secure web access through a designated web portal. The server computer 130 and/or web portal will be configured to provide different security levels depending on the user of the system 100. Professionals who require the gathered data, and have been granted the appropriate level of access by an individual, will be permitted to access the data of the individual according to the level of access granted.

The kiosks 110 may be programmed to provide information to an individual that is customized based on the location of each kiosk 110. For example, a kiosk 110 located at a gym may have information regarding the location of fitness equipment, the location of food and other facilities, information regarding the staff of the gym, and/or instructional information for operation of fitness equipment.

A profile of an individual (a “user profile”) may be initiated and setup on a system 100 in a variety of ways. An individual may create a profile containing information such as general information (e.g., height, weight), health history, goals, picture, etc. The user profile may contain information obtained from a BEIA bar 118 of a kiosk 110. The user profile may contain progress charts, suggestions, chat logs (with professionals) and any other health and wellness related data (e.g., including upcoming appointments, nutrition reminders for the purchase of food, usage data, etc.). The user profile may also include insurance information and any other health history information. The system 100 may thereby be used to report this and other information to insurance companies and physicians.

Individuals may use the system 100 to for varying purposes. For example, the individual may require rehabilitation, training (athletic, military, law enforcement, etc.), or otherwise. The system 100 may be customized depending on such purpose of use. Generally, the information gathered will remain the same for the different purposes; however, system-generated interaction will be different. The system 100 may be programmed with an expert system or other programs for an “Artificial Intelligence Mode” (“AIM”). In this mode, the system may suggest exercise routines, diet, or other information based on the gathered information and the individual's goals. Other individuals may work with professionals and will receive guidance from those professionals. For these individuals, AIM may not be used, although, AIM may still be used by individuals working with professionals. In the case where AIM is used, a professional may have the option of overriding the AIM guidance on a case-by-case basis.

As previously mentioned, the system 100 may be used by individuals having carrying goals. If the individual is a fitness enthusiast and uses the system 100 for his or her own personal information, then the system 100 will keep track and record progress, and make recommendations for improvement for such individual. Because the system 100 uses a networked server computer 130, an individual may access their information from any kiosk 110 location or by way of client computers 170.

The individual may use the system 100 with the goal of rehabilitation or other medical reasons. In such cases, detailed progress information may be gathered and compiled for the individual. For example, data regarding the strength or range of motion for a particular body part may be gathered on a periodic basis. This data may be compiled by the system 100 and presented as, for example, a chart plotting the data over time. Additionally, professionals working with the individual (e.g., a physical therapist, personal trainers, etc.) may access the system 100 to review the individual's progress and detailed results. The system 100 may determine a professional's role and permit access based on the authority granted to that role by the individual.

The system 100 may include a chat function that allows the individual to chat with a professional. The chat function may be an instant messaging system, audio conferencing, video conferencing, or a combination of these.

An individual may use the system 100 for the goal of law enforcement or military training In this application, the individual's progress may be tracked and reported to a professional (e.g., a superior officer, etc.). The professional may use the system 100 to commend the individual or encourage the individual to work harder. In this case, the professional may establish goals that the individual must achieve in a particular period of time.

The system 100 may be used to report information to an insurance company. As such, a report of the individual's progress will be sent and updated on insurance company systems. In this way, the individual demonstrates that he or she is maintaining a certain level of health and wellness.

In any of the above cases, parties will have different levels of access depending on the need of the party and the authority granted by the individual. For example, a personal trainer may not have the same access as a medical professional, nor will a trainer or coach have the same access as an insurance company. The system 100 will only share information with parties that are permitted to view this information through disclosure and consent of the individual. Because, the information is stored on a centralized server, each party—individuals and professionals—enjoys easy access to the information. Each professional will have a specific user account set up to monitor the individual (or individuals). If a user account has basic privileges, then the system 100 will only allow the most basic information about the individual to be revealed (e.g., fitness and nutrition input). Next tier privileged professionals may include physicians and insurance companies. These professionals may have rights to the specific health information and medical-related portions of the system 100. This information will be communicated via a secure network and will be done so with respect to all privacy laws (e.g., HIPAA laws and regulations). This information can be viewed via network login through the web portal, printout, or access of any other computerized device that will be securely networked with the system 100.

In an exemplary embodiment, a system 100, which may be referred to as a “Virtual Lifestyle Management System,” allows an individual to biometrically log into a profile created by that individual. Upon entry to a participating facility (one having a kiosk 110), the individual will scan their biometric information as identification for login. All individual users of the system 100 will have a unique personal identification number (“PIN”) assigned to them, and in extenuating circumstances, with supervision of a reception assistant, the individual can log in utilizing this PIN. In this way, the individual's presence at the facility is recorded in the system 100.

On approaching the kiosk 110, the individual will be prompted by a “Start Screen” to log in to the system 100 using their biometric information. The displayed screen will prompt the individual to place his hands on the BEIA bar 118, a bar that extends from the kiosk. The BEIA bar 118 device will gather body data, including, for example, body fat and internal biological information, and display the results on the kiosk 110 display 114. The gathered data is then stored in the individual's user profile for future reference. The user profile may be stored within the kiosk 110 or the server computer 130. Based on this gathered data, the system 100 can generate graphs and statistics to show current progress and make recommendations to best achieve the goals that were established during the creation of the user profile. In the case that the system 100 is being used for medical or other training purposes, the display may show different items and requirements. For example, if the artificial intelligence mode is enabled, the system 100 will prescribe a workout and exercise schedule, and may show the individual which exercises to perform on which machines (fitness and health center specific), as well as a facility diagram to easily locate them.

Individual uses of the system 100 will also have access to complete nutritional information and areas for individuals to post questions and receive answers. The nutrition information comprises customized diets, recommended recipes, and a nutrition intelligence component. The nutrition intelligence component works in unison with the AIM component and provides a module uses the individual's results (measured, for example, using the BEIA bar) and current diet information to adjust and recommend changes in both diet and workout. All of the information is stored by the system 100 and can be accessed from any Internet accessible device, although additional features may be provided by way of a kiosk 110. In the case that the individual is at home, he is able to log in to access information including daily progress, recipes, and a nutritional shopping list. The shopping list may interact with online food carriers for ease of ordering of food on a regular basis.

Doctors, insurance companies, personal trainers, teachers, coaches, and instructors can all access different levels of this information according to designated permissions. By doing so, the doctors have the ability to monitor true health progress, coaches can view athletes' on and off season progress, instructors can view trainees' progress, and insurance companies can gather statistical data and monitor patient information. By allowing this information to be communicated securely to authorized professionals, the lifestyle of the individual can be improved.

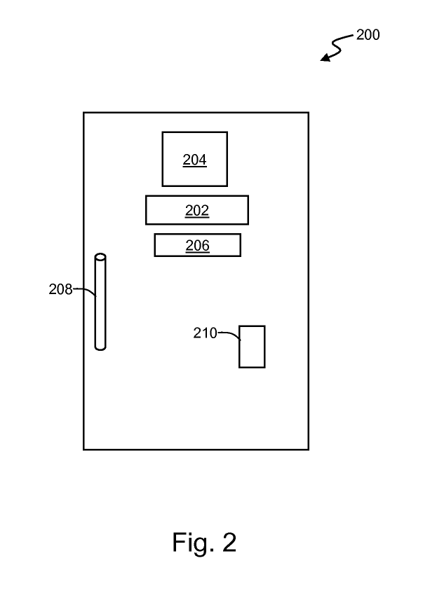

The present invention may also be embodied as a kiosk 200 for managing the wellness of an individual similar to that described above. See, e.g., FIG. 2. The kiosk 200 comprises a processor 202, a display 204 in communication with the processor 202, and a data entry device 206 in communication with the processor 202. The kiosk 202 also comprises a BEIA bar 208 in communication with the processor 202 and a storage device 210 in communication with the processor and capable of storing data received from the data entry device 206. In the case where the kiosk 200 is not provided as part of a system, the kiosk may or may not include a network device.

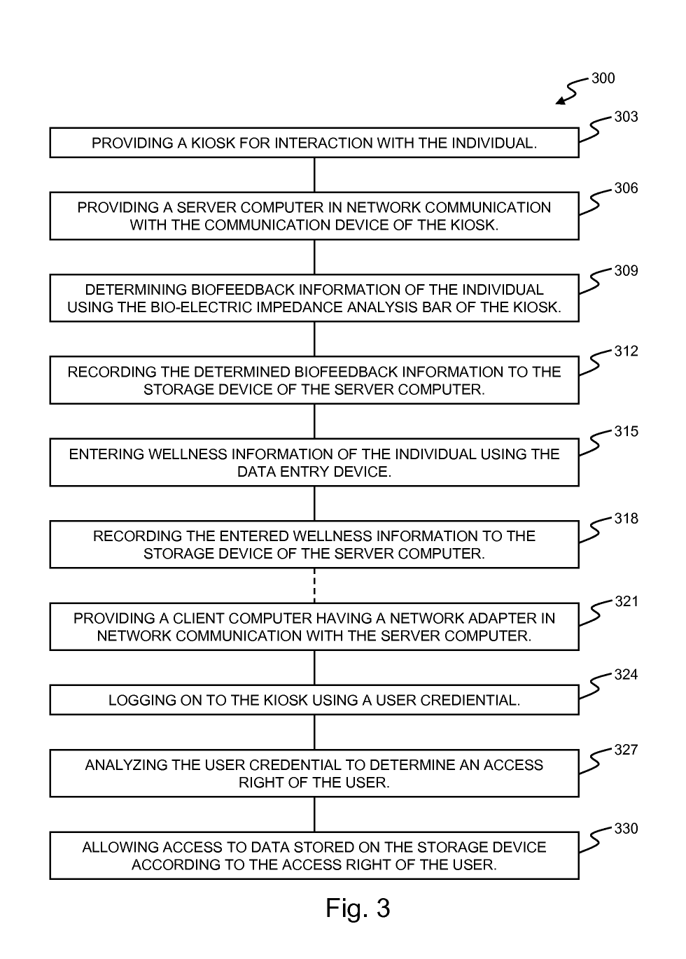

The present invention may be embodied as a method 300 of managing the wellness of an individual. See, e.g., FIG. 3. The method 300 comprises the step of providing 303 a kiosk for interaction with the individual. The kiosk may be similar to the aforementioned kiosks having a processor, a display in communication with the processor, a data entry device in communication with the processor, a bio-electric impedance analysis bar in communication with the processor, and a communication device in communication with the processor and capable of network communication. The method 300 further comprises the step of providing 306 a server computer in network communication with the communication device of the kiosk. The server computer may be similar to the aforementioned server computer having a storage device for storing data received from the individual and communicated form the kiosk.

Biofeedback information of the individual is determined 309 using the bio-electric impedance analysis bar of the kiosk. The biofeedback information may include the individual's heart rate, body fat, body temperature or any other parameter measured by such bio-electric methods. The biofeedback information is recorded 312 to the storage device of the server computer. Wellness information of the individual is entered 315 using the data entry device of the kiosk. The wellness information is recorded 318 to the storage device of the server computer.

The method 300 may further comprise the step of providing 321 a client computer having a network adapter in network communication with the server computer. In this case, a person (individual, professional, or any user of the system) logs 324 on to the kiosk using a user credential. The user credential may be a biometric measurement, a PIN, a swipe card, a user name/password, or other forms of credential commonly known in the art. The user credential is analyzed 327 to determine the access right(s) of the user (e.g., what resources the user is permitted to view, access, change, etc.) Access to the data stored on the storage device is allowed 330 according to the determined access right(s) of the user.

The steps of any method of the present invention may be implemented in varying order. A person having ordinary skill in the art will recognize that these steps may be performed in other sequences, while remaining within the scope of the present invention.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A system for managing the wellness of an individual, comprising:
a kiosk for receiving data from the individual and providing data to the individual, the kiosk comprising:
a processor;
a display in communication with the processor;
a data entry device in communication with the processor;
a bio-electric impedance analysis bar in communication with the processor; and
a communication device in communication with the processor and capable of network communication;
a server computer in network communication with the communication device of the kiosk, the server computer having a storage device for storing data received from the individual and communicated from the kiosk.

2. The system of claim 1, wherein the kiosk further comprises a biometric reader for identification of the individual.

3. The system of claim 1, wherein the data entry device is a touch screen device.

4. The system of claim 1, further comprising fitness equipment having a network adapter in network communication with the kiosk, wherein the fitness equipment sends workout data of the individual to the kiosk.

5. The system of claim 4, wherein the fitness equipment is selected from the group consisting of a treadmill, an elliptical, a rowing machine, a stair machine, and a strength training machine.

6. The system of claim 1, further comprising fitness equipment having a network adapter in network communication with the server computer, wherein the fitness equipment sends workout data of the individual to the server computer.

7. The system of claim 1, further comprising a client computer having a network port in network communication with the server computer.

8. The system of claim 7, wherein the client computer is a portable communication device.

9. The system of claim 1, further comprising medical equipment having a network adapter in network communication with the kiosk, wherein the medical equipment sends medical data to the kiosk.

10. The system of claim 9, wherein the network adapter of the medical equipment is a wireless network adapter.

11. A kiosk for managing the wellness of an individual, comprising:
a processor;
a display in communication with the processor;
a data entry device in communication with the processor;
a bio-electric impedance analysis bar in communication with the processor; and
a storage device in communication with the processor and capable of storing data received from the data entry device.

12. The system of claim 11, wherein the kiosk further comprises a biometric reader for identification of the individual.

13. The system of claim 11, wherein the data entry device is a touch screen device.

14. A method of managing the wellness of an individual, comprising the steps of:
providing a kiosk for interaction with the individual, the kiosk having a processor, a display in communication with the processor, a data entry device in communication with the processor, a bio-electric impedance analysis bar in communication with the processor, and a communication device in communication with the processor and capable of network communication;
providing a server computer in network communication with the communication device of the kiosk, the server computer having a storage device for storing data received from the individual and communicated form the kiosk;
determining biofeedback information of the individual using the bio-electric impedance analysis bar of the kiosk;
recording the determined biofeedback information to the storage device of the server computer;
entering wellness information of the individual using the data entry device;
recording the entered wellness information to the storage device of the server computer.

15. The method of claim 14, wherein determining biofeedback information of the individual further comprises measuring the individual's heart rate, body fat percentage, or body temperature.

16. The method of claim 14, further comprising the steps of:
providing a client computer having a network adapter in network communication with the server computer;
logging on to the kiosk using a user crediential;
analyzing the user credential to determine an access right of the user; and
allowing access to data stored on the storage device according to the access right of the user.
